(19) United States
(12) Patent Application Publication
(10) Pub. No.: US 2013/0208497 A1
(43) Pub. Date: Aug. 15, 2013

(54) INFUSION LINE IDENTIFICATION LIGHTING SYSTEM

(71) Applicants: Wayne A. Provost, Las Vegas, NV (US); Michael A. Pulsipher, Salt Lake City, UT (US)

(72) Inventors: Wayne A. Provost, Las Vegas, NV (US); Michael A. Pulsipher, Salt Lake City, UT (US)

(73) Assignees: UNIVERSITY OF UTAH RESEARCH FOUNDATION, Salt Lake City, UT (US); UNIVERSITY OF UTAH, Salt Lake City, UT (US)

(21) Appl. No.: 13/635,588

(22) PCT Filed: Apr. 5, 2011
(86) PCT No.: PCT/US11/31233

§ 371 Date: Feb. 7, 2013

Related U.S. Application Data
(60) Provisional application No. 61/320,972, filed on Apr. 5, 2010.

(51) Int. Cl. F21V 33/00

(52) U.S. Cl. CPC F21V 33/0068
USPC 362/555; 362/101; 29/428

(57) ABSTRACT

An IV line identification system enables ready identification of an IV line and its associated fluid source and output from other IV lines with their fluid sources and outputs. The IV line identification system includes lights that are coupled to a specific IV line. The lights can identify specific locations on the IV line, such as an entry end by an IV bag and an output end by a needle or port associated with a patient. The lights can also identify the portions of the IV line that enter and exit a pump. The lights can also be selectively turned on when a specific IV line needs to be identified, and turned off when the IV line does not need to be individually identified. The lights may be colored to distinguish between the lights associated with another IV line.

### CROSS-REFERENCE TO RELATED APPLICATIONS

This application claims priority to U.S. provisional patent application No. 61/320,972, filed on Apr. 5, 2010, entitled INFUSION LINE IDENTIFICATION LIGHTING SYSTEM, which is incorporated herein by reference in its entirety.

### BACKGROUND OF THE INVENTION

1. Technical Field

The present invention generally relates to systems for the intravenous administration of medications, fluids, and/or nutrients. More particularly, the invention relates to systems and devices for distinctly identifying each of several intravenous lines used to intravenously administer medications, fluids, and/or nutrients.

2. Related Technology

In a hospital setting patients are often administered liquid medications, fluids, and nutrients (hereinafter collectively referred to as “medications”) via intravenous lines (hereinafter referred to as “IV lines”). IV lines generally consist of flexible, plastic tubing connected at one end to a fluid source and at another end to a needle or port that provides access to a blood vessel or artery of a patient. It is not uncommon for multiple IV lines, each connected to a different source of fluid, to be used simultaneously to deliver several medications at once to a single patient. It is also not uncommon for the needles or ports to be located adjacent one another, such as multiple adjacent needles providing access into the brachial vein running through the arm of the patient.

While the simultaneous use of multiple IV lines can provide numerous benefits, some challenges can also be encountered. For instance, when multiple IV lines are used to administer multiple medications to a single patient, it can become cumbersome and difficult to readily identify one IV line from another. As a result, it can be difficult to quickly and accurately identify a particular medication source and corresponding medication output compared to another medication source and its corresponding medication output. This problem is aggravated by the tendency of each of the intravenous lines to coil up to their packaged configuration and consequently tangle with other IV lines.

Quick identification of a particular medication source is often required in emergency situations. For example, when a patient hooked up to multiple IV lines is in need of emergency intravenous administration of a medication not currently being provided through one of the IV lines, it is necessary to immediately provide that medication. If a blood vessel cannot rapidly be located into which the medication can be injected, it is common practice to provide the drug through an IV line in which a medication is already being administered. This practice of using existing IV lines to administer new medications is also common in non-emergency situations. The person administering the drug, however, must be sure that the IV line through which the new medication is administered is carrying a medication which is compatible with the new medication. Severe results may occur if a new medication is injected through an IV line in which the medication already flowing therethrough is not compatible with the new medication. For example, if heparin is injected into an IV line through which lidocaine is already flowing, a flakey precipitate will form in the mixture which can be dangerous to a patient. Similarly, mixing insulin with certain chemotherapy drugs in a common IV line can be extremely dangerous for a patient.

As a result of the difficulties in distinguishing between multiple IV lines and their associated fluid sources and outputs and the potentially life-threatening possibilities that can occur if incompatible medications are injected through the same IV line, there is a need for devices and systems that allow for ready and accurate identification of individual IV lines with their associated fluid sources and outputs.

### BRIEF SUMMARY OF THE INVENTION

Exemplary embodiments of the invention relate to IV line identification lighting systems and devices to enable the ready identification of one IV line, and its associated fluid source and output, from other IV lines with their associated fluid sources and outputs. In some embodiments, the IV line identification system includes one or more lights that are clipped or otherwise attached to a specific IV line. The one or more lights can be arranged to identify specific locations on an individual IV line. For instance, the one or more lights can identify an entry end of the IV line, such as by an IV bag or syringe, as well as an output end of the IV line, such as by a needle or port associated with a patient. In cases where a pump is used in conjunction with the IV line, the one or more lights can also identify the portion of the IV line that enters the pump and the portion of the IV line that exits the pump. The one or more lights can also be selectively turned on when a specific IV line needs to be identified, and turned off when the IV line does not need to be individually identified. Similarly, the one or more lights may be colored to distinguish between the one or more lights associated with another IV line.

In one exemplary embodiment, the IV line identification system includes one or more lights that can be selectively coupled to an IV line. The one or more lights can be configured to identify a first end and a second end of the IV line. For instance, a first light can be coupled to the first end of the IV line and a second light can be coupled to the second end of the IV line. In another embodiment, an optical fiber is coupled along the length of the IV line to provide a light indicator along the length of the IV line. One or more clips can be used to couple the one or more lights to the IV line. Additionally, a control box is operatively associated with the one or more lights so that the control box can selectively turn the one or more lights on and off.

In another embodiment, the IV line identification system is configured to be used with an IV therapy system that includes a medication source, a pump, a medication output, and an IV line having a first section between the medication source and the pump and a second section between the pump and the medication output. In this embodiment, the IV line identification system includes a first branch and a second branch. The first branch is for association with the first section of the IV line, and the second branch is for association with the second section of the IV line.

The first branch includes one or more lights that can be selectively coupled to the first section of the IV line so as to identify first and second ends of the IV line's first section, the first and second ends being associated with the medication source and the pump, respectively. One or more clips are used to couple the one or more lights of the first branch to the first section of the IV line. Similarly, the second branch include one or more lights that can be selectively coupled to the second section of the IV line so as to identify first and second ends of the IV line's second section, the first and second ends being associated with the pump and the medication output, respectively. One or more clips can be used to couple the one or more lights of the second branch to the second section of the IV line. A control box can be operatively associated with the first and second branches so as to control the one or more lights of the first and second branches.

Still yet another exemplary embodiment of the present invention provide a method for readily distinguishing one IV line from among a plurality of IV lines being used to administer medications to a patient. The method includes providing one or more lighting devices and a control box that is in operative communication with the one or more lighting devices and that is adapted to control the one or more lighting devices. The method further includes selectively coupling a lighting device from the one or more lighting devices to a first end of an IV line, the first end of the IV line being associated with a medication source, and selectively coupling a lighting device from the one or more lighting devices to a second end of the IV line, the second end of the IV line being associated with a medication output. The method also includes illuminating the one or more lighting devices to provide a visual identification for the first end and the second end of the IV line.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a perspective view of an IV line identification system according to an exemplary embodiment of the present invention, the IV line identification system being associated with an IV line;

FIG. 2 illustrates a perspective view of the IV line identification system of FIG. 1, without an associated IV line;

FIG. 3 illustrates a side view of the control box of the IV line identification system of FIG. 1 being clipped onto an associated IV line;

FIG. 4 illustrates an end view of a clip used to attach an IV line identification system to an associated IV line;

FIG. 5 illustrates an end view of a clip used to attach an IV line identification system to an associated IV line, the clip having a light mounted thereon for use in identifying the associated IV line;

FIG. 6 illustrates a perspective view of another exemplary embodiment of an IV line identification system according to present invention, the IV line identification system having two branches for identifying two sections of an associated IV line that result from using a pump in conjunction with the IV line;

FIG. 7 illustrates a perspective view of the IV line identification system of FIG. 4, without an associated IV line;

FIG. 8 illustrates a perspective view of an IV line identification system according to another exemplary embodiment of the present invention, the IV line identification system employing fiberoptics to illuminate an IV line; and

FIG. 9 illustrates a perspective view of yet another exemplary embodiment of an IV line identification system, with the controls for IV line identification system being incorporated into a pump.

### DETAILED DESCRIPTION

The embodiments described herein extend to methods, devices, systems, assemblies, and apparatus for identification of IV lines. Such are configured to, for example, enable the reliable identification of one IV line from another in a simple and efficient manner to prevent the inadvertent injection of incompatible medications through a single IV line.

Reference will now be made to the drawings to describe various aspects of exemplary embodiments of the invention. It is understood that the drawings are diagrammatic and schematic representations of such exemplary embodiments, and are not limiting of the present invention, nor are any particular elements to be considered essential for all embodiments or that elements be assembled or manufactured in any particular order or manner. No inference should therefore be drawn from the drawings as to the necessity of any element. In the following description, numerous specific details are set forth in order to provide a thorough understanding of the present invention. It will be obvious, however, to one of ordinary skill in the art that the present invention may be practiced without these specific details. In other cases, well known aspects of IV lines and related devices and methods, general manufacturing techniques, and the like are not described in detail herein in order to avoid unnecessarily obscuring the novel aspects of the present invention.

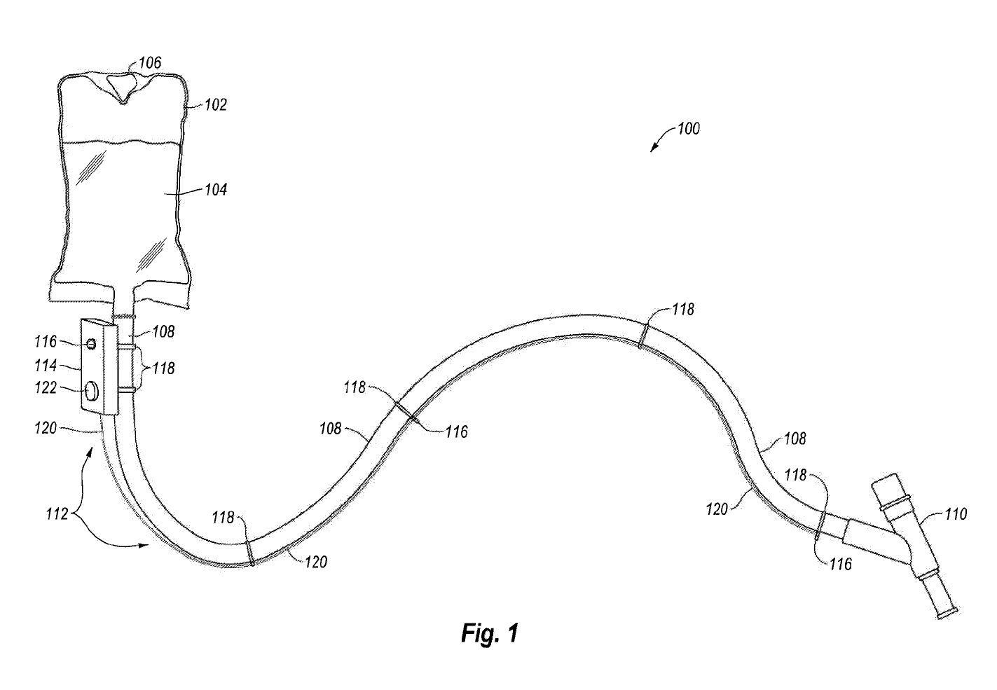

FIGS. 1-7 and the following discussion are intended to provide a brief general description of exemplary devices in which embodiments of the invention may be implemented. While IV therapy apparatuses for administering medications are described below, this is but one single exemplary application for the present invention, and embodiments of the invention may be implemented in other applications, both within the medical field and in other technical fields. Accordingly, throughout the specification and claims, references to medical devices and systems, such as “IV lines,” “IV bags,” “pumps,” “needles,” “ports,” “IV therapy systems,” and the like, are intended to apply broadly to any type of items that may need to be individually identified and distinguished from other similar items, as described herein.

Furthermore, while embodiments of IV therapy systems are shown and described, it will be understood that these are merely exemplary embodiments. Various components of these exemplary embodiments may be excluded or replaced with other components known and used in the art. By way of non-limiting example, some of the exemplary embodiments include IV bags, pumps, and connectors. Each of these components could be eliminated or replaced with other components. For instance, various types of pumps, or no pump at all, can be used with the systems. Similarly, various types of fluid sources and connectors other than IV bags and Y-connectors could be employed.

FIGS. 1-7 thus illustrates examples of suitable IV line identification devices implementing some aspects of the present invention. The IV line identification devices in FIGS. 1-7 are only a few examples of suitable IV line identification devices/systems and are not intended to suggest any limitation as to the scope of use or functionality of an embodiment of the invention. Neither should the devices/systems be interpreted as having any dependency or requirement relating to any one or combination of components illustrated in the systems/devices.

With reference to FIG. 1, there is illustrated an IV therapy system 100 for use in administering medication to a patient. The IV therapy system 100 includes an IV bag 102 having a fluid 104, such as saline, medications, or nutrients, therein. The IV bag 102 includes a loop 106 that enables IV bag 102 to hang from an IV stand or pole (not shown). In other embodiments, IV bag 102 can be replaced with another type of sterile container, such as a glass bottle, a plastic bottle, or a syringe. IV bag 102 is coupled to IV line 108 to convey fluid 104 through IV line 108 to a patient. At an opposing end of IV line 108 is a connector 110. Connector 110 is adapted to connect IV line 108 to an access device (not shown), such as a needle or port, so that fluid 104 can be injected or otherwise introduced into a patient. In the illustrated embodiment, connector 110 is a Y-injection site that allows fluid 104 flowing through IV line 108 to pass therethrough. Additionally, Y-injection site connector 110 also includes an injection port that allows for additional fluid to be injected therein for administration to the patient through the same access device used by IV line 108.

Also illustrated in FIG. 1 is an IV line identification system 112 according to one exemplary embodiment of the present invention. IV line identification system 112 is adapted to be associated with IV therapy system 100 to facilitate ready and accurate identification of IV line 108, and associated IV bag 102 and connector 110, and distinction of IV line 108 from other IV lines and their associated IV bags and connectors. In the illustrated embodiment, IV line identification system 112 includes a control box 114, a plurality of lights 116, and a plurality of clips 118. Clips 118 enable control box 114 and lights 116 to be selectively attached to IV line 108.

Lights 116 can be selectively coupled to IV line 108 at desirable and strategic locations, such as near IV bag 102 and connector 110. With lights 116 coupled to IV line 108, IV line 108, IV bag 102, and connector 110 can be readily and accurately distinguished and identified from other IV lines. That is, when multiple IV lines are being used to administered various medications to a patient, lights 116 can be activated to provide a visual indication to medical personnel that allows for IV line 108, and associated IV bag 102 and connector 110 to be quickly identified and distinguished from other IV lines and their associated IV bags and connectors. More specifically, a first light 116 can be coupled to IV line 108 near IV bag 102 and a second light 116 can be coupled near connector 110 so that when lights 116 are turned on, medical personnel can quickly identify which IV bag is associated with or is supplying medication to which connector.

Thus, when a patient that is already receiving multiple medications through multiple IV lines and a new medication needs to be administered, IV line 108 can be readily identified and distinguished from the other IV lines simply by turning on lights 116. In this manner IV line 108 and its associated IV bag 102 and connector 110 can be quickly identified so that medical personnel can know which IV line can be used to administer the new medication without the risk of injecting the new medication through an IV line that already contains an incompatible medication.

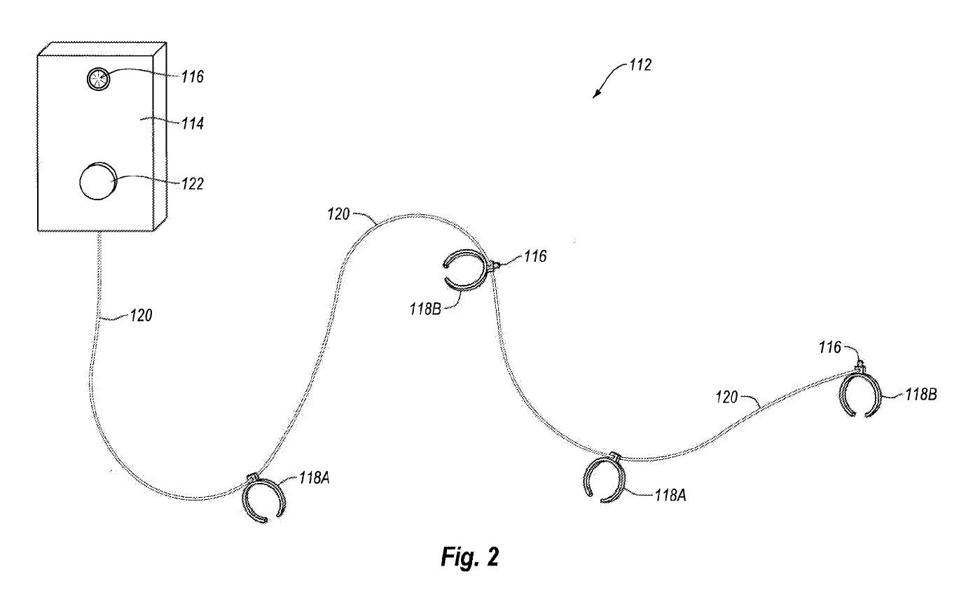

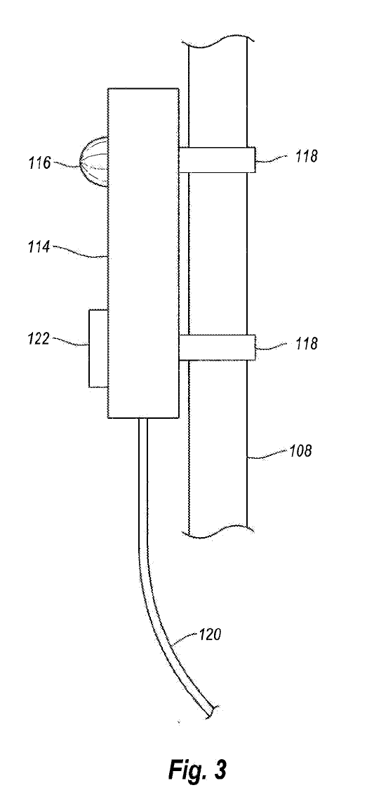

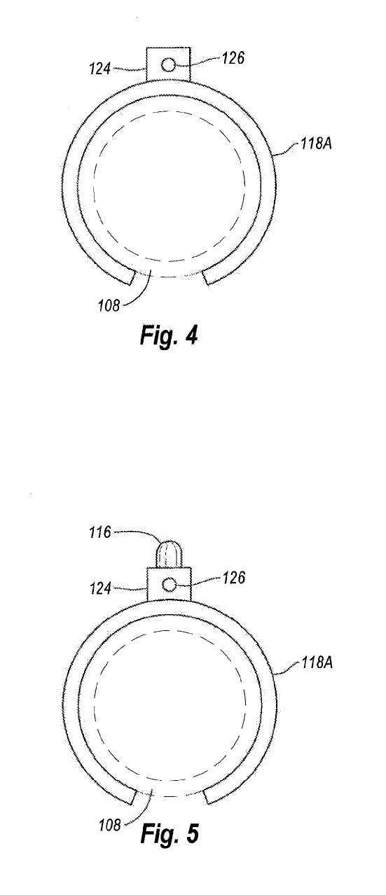

With continued reference to FIG. 1, attention is now also directed to FIGS. 2-5, which illustrate various features of IV line identification system 112 according to the present exemplary embodiment of the invention. FIG. 2 illustrates IV line identification system 112 without the components of IV therapy system 100 being associated therewith, FIG. 3 illustrates control box 114 coupled to IV line 108, and FIGS. 4 and 5 illustrate clips 118 coupling to IV line 108.

As seen in FIGS. 1-3, IV line identification system 112 includes control box 114. In the illustrated embodiment, control box 114 is adapted to provide power to and control the operation of lights 116. Control box 114 can include an internal power source, such as a battery, or control box 114 can include electrical connectors for connecting to an external power source. In either case, control box 114 is adapted to communicate electrical power (from the internal or external power source) to lights 116. As best seen in FIGS. 1 and 2, a wire 120 electrically connects control box 114 and lights 116, and communicates electrical power from control box 114 to lights 116. Control box 114 also includes a power button 122 that enables lights 116 to be selectively turned on and off. Thus, when IV line 108, associated IV bag 102, and connector 110 need to be identified, power button 122 can be pressed to turn lights 116 on, thereby providing a visual indication of IV line 108, and associated IV bag 102 and connector 110.

Control box 114 includes two clips 118 to facilitate selective coupling of control box 114 to IV line 108, as shown in FIGS. 1 and 3. Similar to the other clips 118 shown in FIGS. 2, 4, and 5, clips 118 on control box 114 can be generally circular with an opening to allow for IV line 108 to be inserted therein. Thus, clips 118 on control box 114 enable control box 114 to be selectively secured onto a desired location on IV line 108 and removed from IV line 108 when not needed.

As shown in FIG. 1, control box 114 can be coupled at one end of IV line 108, such as near IV bag 102. As also shown in the Figures, control box 114 includes a light 116. Thus, when lights 116 are turned on, light 116 on control box 114 provides a visual indication to medical personnel regarding IV line 108. Specifically, when light 116 on control box 114 is turned on, medical personnel can quickly identify which of multiple fluid sources (i.e., IV bags) is supplying medication to IV line 108.

In the illustrated embodiment, clips 118 can be attached at various locations along the length of IV line 108. Clips 118 can be adapted to be selectively coupled to or removed from IV line 108 as desired or needed. In the illustrated embodiment, clips 118 come in two forms. The first form is a clip 118A, shown in FIG. 4, which is generally circular with an opening through which IV line 108 can be inserted to couple clip 118A to IV line 108. IV line 108 is shown in dashed lines within clip 118A.

Clip 118A has a mount 124 thereon. Mount 124 is adapted to hold wire 120 so that when clip 118A is coupled to IV line 108, clip 118A holds wire 120 relatively close to IV line 108 so that wire 120 does not hang down or get tangled with other wires or IV lines. In the illustrated embodiment, mount 124 has an aperture 126 therethrough which is adapted to have wire 120 pass therethrough. In other embodiments, mount 124 can hold wire 120 using clips, adhesives, press-fit recesses, and the like.

A second form of clip 118 is a clip 118B as illustrated in FIG. 5. Clip 118B is similar to clip 118A in that clip 118B is generally circular with an opening through which IV line 108 can be inserted to couple clip 118B to IV line 108. IV line 108 is shown in dashed lines within clip 118B. Clip 118B also includes a mount 124 and an aperture 126 through which wire 120 can pass. In addition, clip 118B also has a light 116 mounted on mount 124. Light 116 is in electrical communication with wire 120. Thus, when power button 122 is activated on control box 114, the electrical power that is communicated over wire 120 turns on light 116.

Clips 118B can be coupled to IV line 108 to provide a visual indication to medical personnel regarding specific locations along IV line 108. For instance, when control box 114 is coupled to IV line 108 near IV bag 102, a clip 118B can be coupled to IV line 108 near connector 110 so that medical personnel can quickly identify that IV bag 102 and connector 110 are associated with IV line 108. In other embodiments, a first clip 118B can be coupled to IV line 108 near IV bag 102 and a second clip 118B can be coupled to IV line 108 near connector 110 to provide the same information to medical personnel. Additional clips 118B can be provided at other locations along the length of IV line 108 to provide a visual indication to assist medical personnel in identifying IV line from other IV lines.

Thus, in circumstances where a patient is having multiple medications administered through multiple IV lines, one or more of the IV lines can be equipped with an IV line identification system 112 as described above. That is, one or more of the IV lines can have a control box and multiple lights coupled thereto to provide a mechanism for readily and accurately identifying an individual IV line and distinguishing a specific IV line from the other IV lines.

In one implementation of the present invention, each of multiple IV lines is equipped with an IV identification system 112, as described above. When a new medication needs to be administered, medical personnel can first locate an IV bag 102 that contains a medication that is compatible with the new medication. The medical personnel can then activate the power button 122 on the control box 114 that is mounted near the IV bag 102 on the IV line 108 associated with the IV bag 102. Activating the power button 112 will turn on each of the lights 116 associated with the specific IV identification system 112, including a light 116 coupled to IV line 108 near connector 110 that is associated with the selected IV bag 102. This allows medical personnel to readily locate the connector 110 that is associated with the selected IV bag 102. The new medication can then be introduced into the IV line 108 through connector 110 that is associated with the selected IV bag 102. In other words, the lights 116 on a specific IV line 108 can provide to medical personnel a quick visual reference that indicates which IV bag is associated with which connector, thereby allowing them to quickly and safely identify where a new medication can be introduced without the risk of introducing the new medication into an IV line that contains an incompatible medication.

Notably, the present invention's employment of lights to identify IV lines provides several advantages. For instance, often medical personnel check IV lines and administer medications in a patient's hospital room. This may be done during the evening or at night when room lights are turned off to allow the patient to sleep. Without the present invention, medical personnel would have to turn on the room lights, which may disturb the resting patient, in order to be able to safely identify an acceptable IV line that can be used for the administration of a new medication. In contrast, the present invention allows for the identification of an acceptable IV line without having to turn on a room light that may disturb a sleeping patient. Rather, medical personnel can simply activate the power button on the control box to turn on the lights associated with the IV line. The lights can be bright enough to allow safe identification of the IV line while not being so bright as to disturb a resting patient.

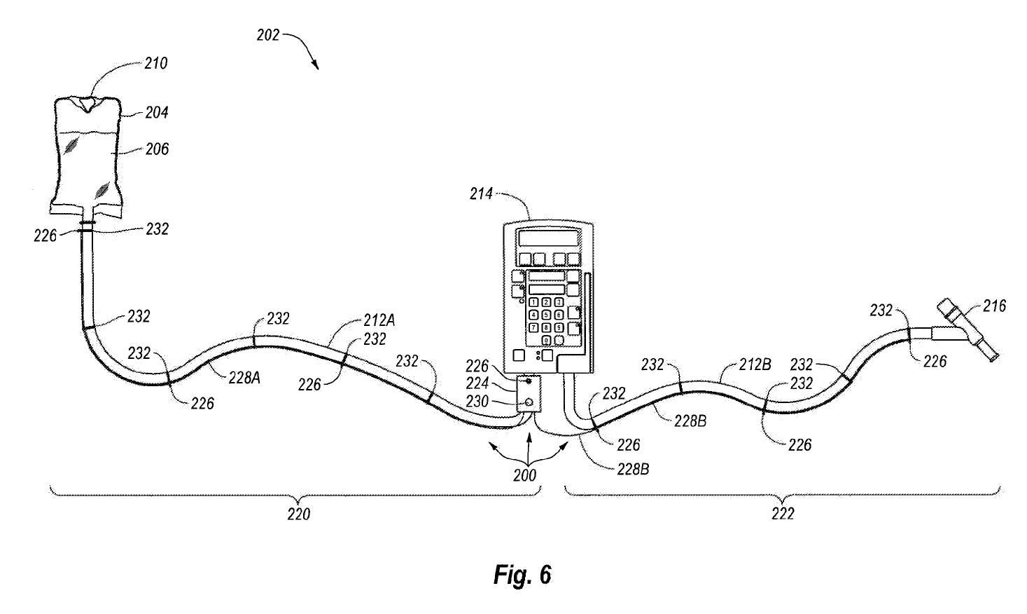

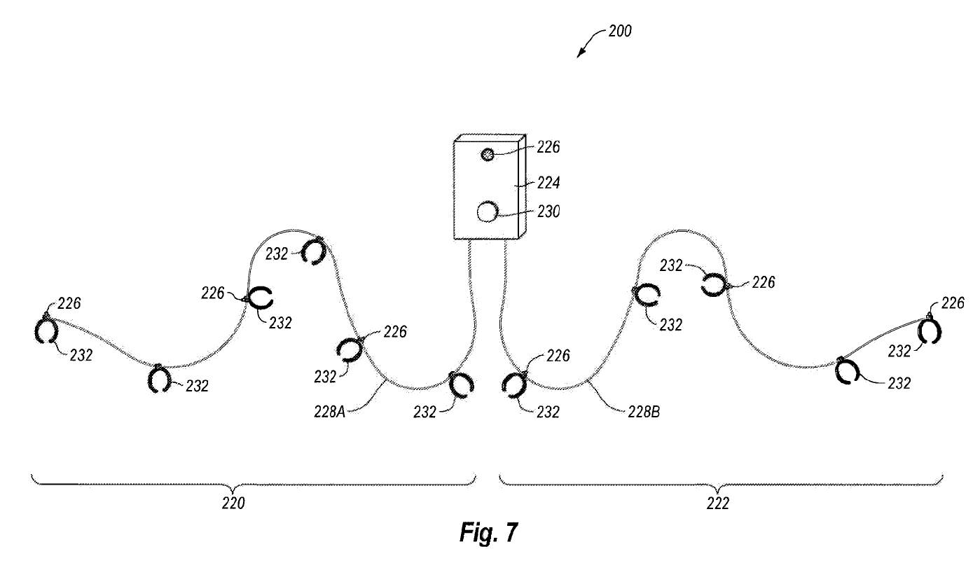

Attention is now directed to FIGS. 6 and 7, which illustrate an IV line identification system 200 according to an alternative exemplary embodiment of the present invention. IV line identification system 200 can be used in connection with IV therapy system 100, illustrated in FIG. 1. Alternatively, IV line identification system 200 can be used in connection with IV therapy system 202, illustrated in FIG. 6. As shown in FIG. 6, IV therapy system 202 includes components similar to those of IV therapy system 100. In particular, IV line identification system 200 includes an IV bag 204 having a fluid 206 therein that can be administered to a patient through a connector 216. IV bag 204 includes a loop 210 for hanging IV bag 204 from an IV stand or pole. Unlike IV therapy system 100 which has a single IV line 108 that extends between IV bag 102 and connector 110, IV therapy system 202 includes an IV line 212 having a first section 212A that extends between IV bag 204 and a pump 214, and a second section 212B that extends between pump 214 and connector 216.

As is well known in the art, IV therapy systems often employ various types of infusion pumps, including syringe pumps, to regulate the flow of medication to a patient over time. In the illustrated embodiment, fluid 206 is passed from IV bag 204 to a pump 214 through first section 212A of IV line 212. Pump 214 regulates the flow rate of fluid 206 through IV line 212. Fluid 206 then flows from pump 214 to connector 216 through second section 212B of IV line 212.

When an IV therapy system, such as system 202, is employed to administer medications to a patient, IV identification system 200 can be employed to provide ready identification of various desired locations along IV line 212. Readily identifying certain locations along IV line 212 can enable medical personnel to identify IV lines which can be used to administer a new medication without the risk of mixing incompatible medications.

IV identification system 200 according to the present exemplary embodiment includes a first branch 220 adapted to be associated with first section 212A of IV line 212, a second branch 222 adapted to be associated with second section 212B of IV line 212, and a control box 224. First branch 220 and second branch 224 each include multiple lights 226 coupleable to IV line 212 for identifying various desired locations along the length of IV line 212. For instance, first branch 220 includes a first light 226 coupled to first section 212A near IV bag 204 and a second light 226 coupled to first section 212A near pump 214. Similarly, second branch 222 includes a first light 226 coupled to second section 212B near pump 214 and a second light 226 coupled to second section 212B near connector 216.

As with IV line identification system 112, lights 226 are mounted on clips 232, which enable lights 226 to be selectively coupled to and removed from IV line 212. Additionally, IV line identification system 200 also includes multiple clips 232 which do not have lights 226 mounted thereon. Rather, these clips 232 couple wires 228A and 228B to IV line 212. This helps to prevent wires 228A and 228B from hanging too low or becoming tangled with other wires or IV lines.

As shown in FIGS. 6 and 7, control box 224 is electrically coupled to lights 226 via wires 228A and 228B. As with control box 114, control box 224 can have an internal power source, such as a battery, or control box 224 can be adapted to receive electrical power from an external source. For instance, in the illustrated embodiment, control box 224 is mounted on IV line 212 near pump 214. Control box 224 can include an electrical connector (not shown) which can be plugged into pump 214 to receive electrical power therefrom. Control box 224 can communicate the electrical power, whether from an internal or external source, to lights 226. Control box 224 also includes a power button 230 to selectively turn on/off lights 226.

When turned on, lights 226 provide a visual indication to medical personnel regarding which components of IV therapy system 202 are related compared to other IV therapy systems concurrently being used on the same patient. That is, when lights 226 are turned on, medical personnel can quickly and accurately determine which IV bag is associated with which pump and which connector. Thus, in a manner similar to that described above, once medical personnel have identified an IV bag that contains a medication that is compatible with a new medication that needs to be given, the medical personnel can quickly identify the other strategic locations on the IV line. For instance, lights 226 can be coupled to IV line 212 in strategic locations such as near IV bag 204, near the entry of first section 212A into pump 214, near the exit of second section 212B from pump 214, and near connector 216. Thus, when an IV bag containing a compatible medication is identified, the medical personnel can activate power button 230 to turn on lights 226. This will provide a visual indication to the medical personnel regarding, for example, which connector is associated with the IV bag and, thus, where the new medication can be injected.

In light of the disclosure herein, it will be understood that a method for readily distinguishing one IV line from among a plurality of IV lines being used to administer medications to a patient can include the following steps. The method includes providing one or more lighting devices and a control box that is able to communicate with and control the one or more lighting devices. Lighting devices from the one or more lighting devices are selectively coupled to first and second ends of an IV line, near a medication source and a medication output. The one or more lighting devices are illuminated to provide a visual identification for the first and second ends of the IV line. In this manner, medical personnel can identify specific location in an IV therapy system, such as a medication source and output. This method can also include selectively coupling a lighting device from the one or more lighting devices to a first and second intermediate portion of the IV line, the first and second intermediate portions being associated with entry and exit locations, respectively, of a pump.

In addition to the embodiments described above, various alternative embodiments or modifications to the above-described embodiments can be used or incorporated into the present invention. By way of non-limiting example, rather than electrically connecting each of the lights of the IV line identification system by way of a wire to provide power to the lights, one or more of the lights could be equipped with individual power sources. In connection with this embodiment, the control box may be adapted to wirelessly control the lights. For instance, the control box may be equipped with a transmitter that can communicate a wireless signal to the lights, and the lights could be equipped with a receiver for receiving the wireless signals from the control box. Thus, when the power button on the control box is pressed, the control box would transmit a wireless control signal to the lights to turn the lights on or off.

In another embodiment, rather than using individual lights to provide an indication at certain locations along an IV line, or a section thereof, a light could be coupled at one end of the IV line (or a section thereof) and an optical fiber could be coupled along a length of the IV line (or the section thereof) so as to illuminate the entire length of the IV line (or the section thereof).

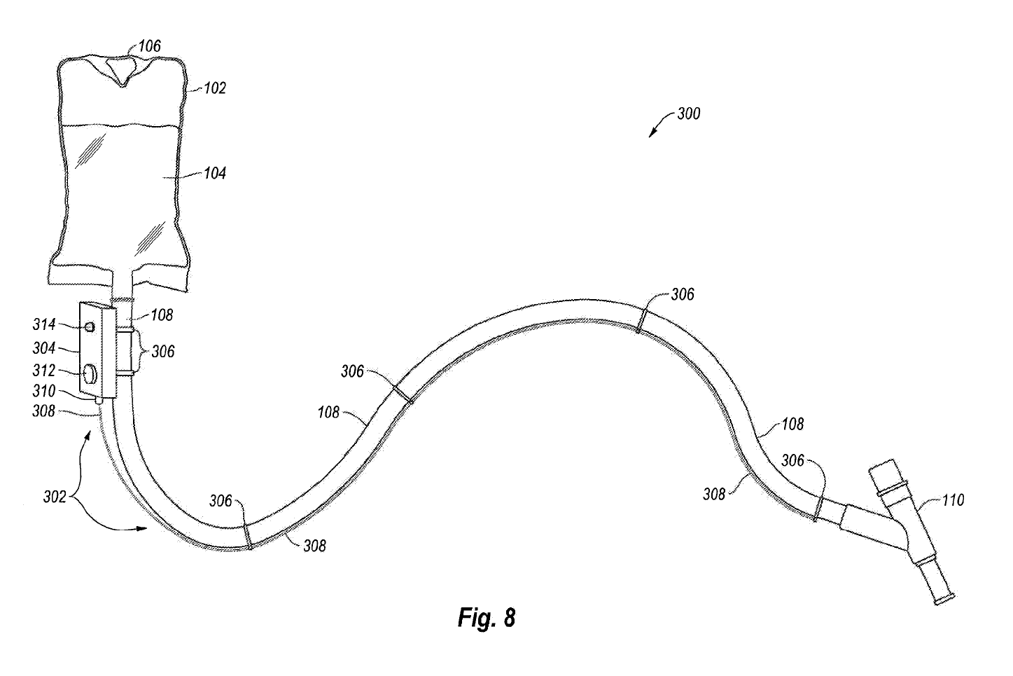

For instance, FIG. 8 illustrates an IV therapy system 300 that is similar to IV therapy system 100 illustrated in FIG. 1. In particular, IV therapy system 300 includes an IV bag 102 having a fluid 104, such as saline, medications, or nutrients, therein. IV bag 102 includes a loop 106 that enables IV bag 102 to hang from an IV stand or pole (not shown). In other embodiments, IV bag 102 can be replaced with another type of sterile container, such as a glass bottle, a plastic bottle, or a syringe. IV bag 102 is coupled to IV line 108 to convey fluid 104 through IV line 108 to a patient. At an opposing end of IV line 108 is a connector 110. Connector 110 is adapted to connect IV line 108 to an access device (not shown), such as a needle or port, so that fluid 104 can be injected or otherwise introduced into a patient. In the illustrated embodiment, connector 110 is a Y-injection site that allows fluid 104 flowing through IV line 108 to pass therethrough. Additionally, Y-injection site connector 110 also includes an injection port that allows for additional fluid to be injected therein for administration to the patient through the same access device used by IV line 108.

Like IV therapy system 100, IV therapy system 300 also includes an IV line identification system to facilitate ready and accurate identification of IV line 108, and associated IV bag 102 and connector 110, and distinction of IV line 108 from other IV lines and their associated IV bags and connectors. Similar to IV line identification system 112 shown in FIGS. 1 and 2, IV line identification system 302 of the present embodiment includes a control box 304 (having a power button 312 and a light 314) and a plurality of clips 306. Unlike IV line identification system 112, which includes multiple individual lights connected at various locations on IV line 108, IV line identification system 302 includes an optical fiber 308 that can be connected along the length of IV line 108 with clips 306. At one end of optical fiber 308 is a light 310 that can illuminate optical fiber 308. Thus, by activating power button 312 on control box 304, lights 310 and 314 can be turned on. Light 314 provides an indication of which control box has been activated and light 310 directs light through optical fiber 308. The light that passes within optical fiber 308 illuminates or provides a visual indication along the length of IV line 108, thereby allowing medical personnel to quickly and accurately identify which IV bag and connector are associated with IV line 108 while distinguishing IV line 108 from other IV lines associated with a patient.

Thus, simply by turning on light 310 and illuminating TV line 108 with optical fiber 308, IV line identification system 302 allows medical personnel to readily identify and distinguish IV line 108, and its associated fluid source and connector, from other IV lines that are supplying medication to a patient. In this manner IV line 108 and its associated IV bag 102 and connector 110 can be quickly identified so that medical personnel can know which IV line can be used to administer a new medication without the risk of injecting the new medication through an IV line that already contains an incompatible medication.

In light of the disclosure herein, it will be appreciated that the embodiment shown in FIG. 8 can be readily modified as desired and needed for application to other types of IV therapy systems. By way of non-limiting example, a fiberoptic IV line identification system could be employed in connection with an IV therapy system that includes two or more branches, such as the system shown in FIG. 6. For instance, the IV line identification system could have a single optical fiber that is coupled along and illuminates both branches of the IV line. Alternatively, multiple optical fibers could be employed to illuminate the branches of the system. For example, an individual optical fiber could be associated with and illuminate each branch of the IV line.

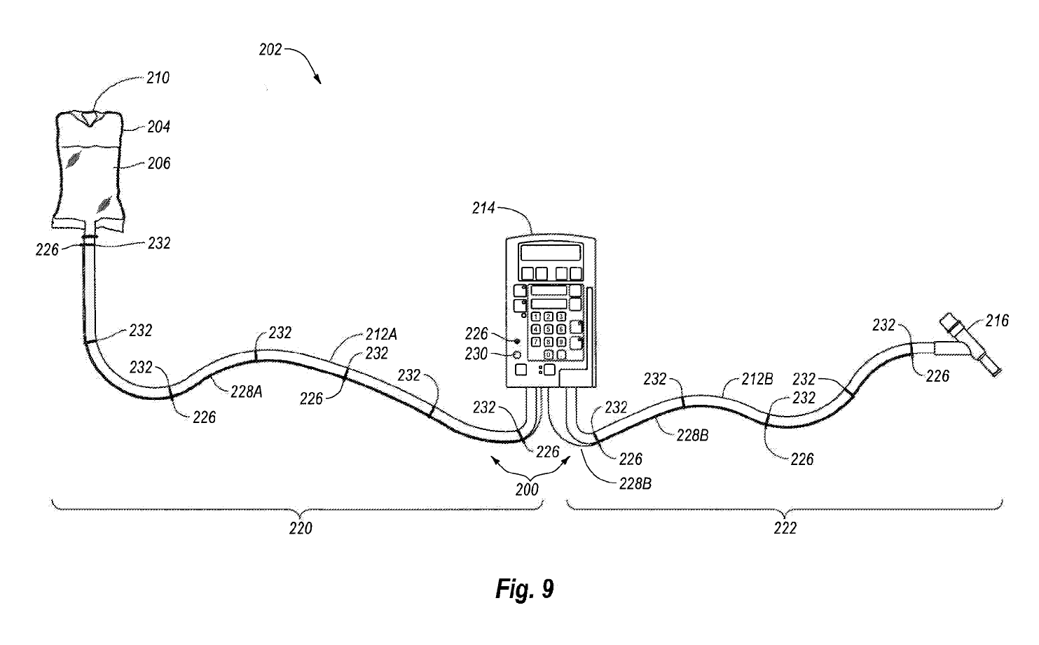

In another embodiment, the control box could be incorporated into another device associated with the IV therapy system. FIG. 9 illustrates one exemplary embodiment in which the control box is incorporated into another device of the IV therapy system. As can be seen in FIG. 9, the IV therapy system and IV line identification system are generally the same as the embodiment illustrated in FIG. 6, except that the IV line identification system does not have a dedicated control box for controlling lights 226. Rather control box 224 (and its functionality) from FIG. 6 has been incorporated into pump 214. More specifically, pump 214 includes a light 226 and a power button 230. Additionally, instead of first and second branches 220 and 224 of the IV line identification system being connected to a separate control box, each branch is connected to pump 214. The connection between each branch and pump 214 can be a permanent connection or a selective connection. With a permanent connection, wires 228A and 228B from first and second branches 220 and 224 can be wired into pump 214. Alternatively, wires 228A and 228B and pump 214 can be equipped with connectors (i.e., plug and socket) that enable wires 228A and 228B to be selectively connected to pump 214. When connected, medical personnel can activate power button 230 to turn lights 226 on, thereby illuminating various locations on the branches of the IV line.

In yet another embodiment, in addition to or rather than turning the lights on and off each time an IV line needs to be identified, the light(s) for each IV line can be color coded. For example, in a situation where multiple IV lines are being used to administer different medications to a patient, each of the IV lines could have an IV line identification system associated therewith, and the light(s) of each IV line identification system could be different colors. Thus, a first IV line could have red lights, a second IV line could have green lights, a third IV line could have blue lights, and so on. In this embodiment, the lights of each IV line identification system could remain on and the medical personnel would merely need to look for corresponding colored lights to identify components of the same IV line.

In other embodiments, the control box could be adapted to hang from an IV stand or pole, such as the same IV stand or pole on which hangs the IV bag associated with the control box. Furthermore, the IV line identification systems according to the present invention can be configured to be cleaned, sterilized, and reused.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An IV line identification system for the ready identification of one IV line from another IV line, the IV line identification system comprising:
an IV therapy system for administering medication to a patient, the IV therapy system comprising:
a medication source in which a medication can be disposed;
an IV line in fluid communication with the medication source for communicating the medication from the medication source to a medication output; and
a medication output associated with a patient, the medication output being adapted for fluid communication with the IV line for communicating the medication from the IV line to the patient;
one or more lights adapted to be selectively coupled to the IV line, wherein the one or more lights are adapted to identify the medication source and the medication output;
one or more clips adapted to couple the one or more lights to the IV line; and
a control box operatively associated with the one or more lights, wherein the control box is adapted to selectively turn the one or more lights on and off.

2. An IV line identification system as recited in claim 1, wherein the one or more lights comprise a plurality of lights.

3. An IV line identification system as recited in claim 2, wherein the plurality of lights comprises a first light that can be selectively coupled to the IV line next to the medication source and a second light that can be selectively coupled to the IV line next to the medication output to facilitate ready identification of the medication source and the medication output of the IV therapy system.

4. An IV line identification system as recited in claim 3, wherein the first light is coupled to the control box and the second light is coupled to one of the one or more clips.

5. An IV line identification system as recited in claim 1, wherein the one or more lights comprise an LED and a fiber optic cable, wherein the fiber optic cable is adapted to be coupled along a length of the IV line with the one or more clips, and wherein the LED is adapted to direct light through the fiber optic cable to facilitate ready identification of the IV line.

6. An IV line identification system as recited in claim 1, further comprising a wire electrically connecting the control box and the one or more lights.

7. An IV line identification system as recited in claim 6, wherein the control box is adapted to be electrically connected to an external power source to receive electrical power, wherein the control box is adapted to communicate the electrical power over the wire to the one or more lights.

8. An IV line identification system as recited in claim 6, wherein the control box comprises a power source adapted to provide electrical power to the one or more lights.

9. In an IV therapy system comprising a medication source, a pump, a medication output, and an IV line having a first section between the medication source and the pump and a second section between the pump and the medication output, an IV line identification system adapted to enable multiple IV lines to be readily distinguished from one another, the IV line identification system comprising:
a first branch adapted to be associated with the first section of the IV line, the first branch comprising:
one or more lights adapted to be selectively coupled to the first section of the IV line, wherein the one or more lights of the first branch are adapted to identify a first location and a second location on the IV line's first section, wherein the first location on the IV line's first section is associated with the medication source and the second location on the IV line's first section is associated with the pump; and
one or more clips adapted to couple the one or more lights of the first branch to the first section of the IV line;
a second branch adapted to be associated with the second section of the IV line, the second branch comprising:
one or more lights adapted to be selectively coupled to the second section of the IV line, wherein the one or more lights of the second branch are adapted to identify a first location and a second location on the IV line's second section, wherein the first location on the IV line's second section is associated with the pump and the second location on the IV line's second section is associated with the medication output; and
one or more clips adapted to couple the one or more lights of the second branch to the second section of the IV line; and
a control box operatively associated with the first and second branches, wherein the control box is adapted to control the one or more lights of the first and second branches.

10. An IV line identification system as recited in claim 9, wherein the control box comprises one or more clips adapted to couple the control box to the first section or the second section of the IV line.

11. An IV line identification system as recited in claim 9, wherein the one or more lights selectively coupled to the first section of the IV line comprise a first light selectively coupled to the first location on the IV line's first section and a second light selectively coupled to the second location on the IV line's first section.

12. An IV line identification system as recited in claim 9, wherein the one or more lights selectively coupled to the second section of the IV line comprise a first light selectively coupled to the first location on the IV line's second section and a second light selectively coupled to the second location on the IV line's second section

13. An IV line identification system as recited in claim 9, wherein the control box is adapted to selectively turn on and off the one or more lights of the first and second branches.

14. An IV line identification system as recited in claim 9, wherein the control box is adapted to wirelessly communicate with the one or more lights of the first branch and the second branch.

15. An IV line identification system as recited in claim 9, wherein each of the one or more lights of the first branch and the second branch comprises an individual power source.

16. An IV line identification system as recited in claim 9, wherein the one or more lights of the first branch and the second branch are the same color.

17. A method for readily distinguishing one IV line from among a plurality of IV lines being used to administer medications to a patient, the method comprising:
providing one or more lighting devices;
providing a control box in operative communication with the one or more lighting devices, the control box being adapted to control the one or more lighting devices;
selectively coupling a lighting device from the one or more lighting devices to a first location on an IV line, the first location on the IV line being associated with a medication source, wherein the lighting device is adapted to be illuminated;
selectively coupling a lighting device from the one or more lighting devices to a second location on the IV line, the second location on the IV line being associated with a medication output, wherein the lighting device is adapted to be illuminated; and
illuminating the one or more lighting devices to provide a visual identification for the first location and the second location on the IV line.

18. A method as recited in claim 17, wherein the control box is adapted to selectively illuminate the one or more lighting devices.

19. A method as recited in claim 17, further comprising:
selectively coupling a lighting device from the one or more lighting devices to a first intermediate portion of the IV line, wherein the first intermediate portion of the IV line is associated with an entry location of a pump, wherein the lighting device is adapted to be illuminated; and
selectively coupling a lighting device from the one or more lighting devices to a second intermediate portion of the IV line, wherein the second intermediate portion of the IV line is associated with an exist location of the pump, wherein the lighting device is adapted to be illuminated.

20. A method as recited in claim 19, wherein selectively coupling a lighting device to the first location, the second location, the first intermediate portion, and the second intermediate portion of the IV line comprises selectively coupling separate lights to the first location, the second location, the first intermediate portion, and the second intermediate portion of the IV line.
